(19) United States
(12) Patent Application Publication
(10) Pub. No.: US 2019/0361895 A1
(43) Pub. Date: Nov. 28, 2019

(54) METHODS AND SYSTEMS FOR A DATABASE

(71) Applicant: Fauna, Inc., San Francisco, CA (US)

(72) Inventors: Evan Andrew Weaver, Kensington, CA (US); Matthew Barrett Freels, Berkeley, CA (US); Brandon Tyler Mitchell, San Francisco, CA (US); Jeffrey William Smick, Lafayette, CA (US); Edward Alexander Ceasar, San Francisco, CA (US); Attila Szegedi, Szeged (HU)

(73) Assignee: Fauna, Inc., San Francisco, CA (US)

(21) Appl. No.: 16/539,377

(22) Filed: Aug. 13, 2019

Related U.S. Application Data
(63) Continuation of application No. PCT/US2018/022653, filed on Mar. 15, 2018.
(60) Provisional application No. 62/471,584, filed on Mar. 15, 2017.

(51) Int. Cl. G06F 16/2458; G06F 16/248; G06F 16/28; G06F 16/22; G06F 16/27

(52) U.S. Cl. CPC G06F 16/2471; G06F 16/248; G06F 16/27; G06F 16/221; G06F 16/2228; G06F 16/285

(57) ABSTRACT

A database system for data storage and retrieval generally includes a transactional database having a distributed data architecture providing real-time access to a dynamic data set configured to accept a query expression to the transactional database is abstracted from at least one underlying data structure of the transactional database. The database system includes a user interface configured for users to query the transactional database via queries using the query expression. The transactional database delivers a response to a query that reflects a current state of data in the dynamic data set.

### CROSS-REFERENCE TO RELATED APPLICATIONS

This application is a continuation of International Application No. PCT/US2018/022653, filed Mar. 15, 2018, which claims the benefit of U.S. Provisional Patent Application No. 62/471,584, filed Mar. 15, 2017, entitled Methods and Systems for a Database, both of which are hereby incorporated by reference as if fully set forth herein.

### BACKGROUND

### 1. Field

The present disclosure relates to methods and system for a database as well as methods and system deploying a transactional database having a distributed data architecture providing real-time access to a dynamic data set configured to accept a query expression to the transactional database is abstracted from at least one underlying data structure of the transactional database.

### 2. Description of Related Art

Conventional enterprise databases were created and optimized primarily for running business reports. Enterprises increasingly need databases that support operational functions, such as applications that are deployed at scale and in a variety of distributed environments, including mixtures of on-premises and cloud environments. Operational functions need access to data in real time, from a variety of geographic locations. While conventional enterprise databases use conventional database query forms, such as SQL queries or NoSQL queries, relevant operational data on which applications, processes and services operate may take a much wider variety of forms from different domains, such as relational, document, graph, geospatial and temporal domains. As enterprise workflows involve extensive interactions among users, processes, applications, and the like, both inside and outside the enterprise (often involving multi-tenancy and access by users with varying access rights), and involving SaaS, web, mobile and premises applications and operations, conventional database security systems that apply security at the level of the logical database do not provide sufficient granularity. Because they cannot effectively isolate processes at a granular level, conventional databases typically separate high value processes (such as ones that support critical operations) from lower value processes (such as ones that support analytics), resulting in entirely different databases being used for different functions, often resulting in a high degree of underutilization of expensive hardware that needs to be provisioned for peak demand. Accordingly, a need exists for an improved database platform, including a database that addresses these and other limitations of conventional databases.

### SUMMARY

Methods and systems are provided herein for an improved database platform, with database features that allow significant improvement in operational and other databases used by enterprises. These include a unified query model that can handle different query domains, such as relational, key/value, document, search, geospatial, graph and temporal queries. The database platform may include improved security features, including row-level security, row-level authentication, and/or row-level identity, among others. Process isolation, including for QoS, allows prioritization of queries run against the same database, thereby enabling high value operations-relevant queries and lower value queries to be handled in the same database, reducing hardware demands and reducing hardware underutilization. Multi-tenancy is enabled, as is global distribution and strongly consistent replication, including with selection of geographic zones for data storage. These and many other features and capabilities are described in the present disclosure.

In embodiments, an architecture for a database is provided that has functional parity with SQL-based databases and a feature set that encompasses SQL and NoSQL database features. In embodiments, a database is provided that enables both SQL and NoSQL features and that enables the use of a relational query model. In embodiments, a relational database is provided that enables the use of one or more additional query models, including search, graph, temporal, geospatial, key/value, document, and analytics query models.

In embodiments, a relational database language is provided that enables the use of heterogeneous query models. In embodiments, a database is provided that includes row-level security. In embodiments, a database is provided that provides row-level handling of identity. In embodiments, a database is provided that provides row-level authentication. In embodiments, a database is provided that provides an elastic architecture. In embodiments, a database is provided that enables masterless configuration and operation. In embodiments, a database is provided that enables recursive multi-tenancy configuration and operation. In embodiments, a database is provided that can be replicated to multiple geographically diverse data centers or cloud infrastructure providers. In embodiments, a functional, relational query language is provided for a database.

In embodiments, a database is provided with process isolation capabilities. In embodiments, recursive scheduling is provided to enable process isolation for a database. In embodiments, a recursive implementation of completely fair queuing is provided in connection with process isolation for a database. In embodiments, dynamic resource scheduling is provided for a database, including across a database cluster. In embodiments, dynamic resource scheduling for a database is provided on a query-by-query basis. In embodiments, dynamic resource scheduling is provided for a database on a user-by-user basis. A distributed storage layer for a database is provided herein. A distributed storage layer may be provided with a transaction resolution algorithm for a distributed database.

In embodiments, a replication algorithm is provided for a distributed database, such as using a replication log that replicates information to different storage nodes. In embodiments, an on-disk storage engine is provided for a distributed database. In embodiments, a database is provided having per query quality-of-service management. In embodiments, a database is provided that enables execution of background analytic tasks in the database. In embodiments, a direct acyclic task graph is operated against an operational database. In embodiments, the database may include columnar analytics capabilities. In embodiments, a database is provided that enables streaming queries.

In embodiments, a database system for data storage and retrieval includes a transactional database having a distributed data architecture providing real-time access to a dynamic data set configured to accept a query expression to the transactional database is abstracted from at least one underlying data structure of the transactional database. In embodiments, the database system includes a user interface configured for users to query the transactional database via queries using the query expression. The transactional database delivers a response to a query that reflects a current state of data in the dynamic data set.

In embodiments, a user interface facilitates simultaneous queries by a plurality of users. In embodiments, the transactional database facilitates responses to queries by at least one thousand users without substantially impairing a time required to return a response to a query. In embodiments, the transactional database uses a functional query language. In embodiments, the transactional database uses a consensus algorithm for at least one of locking and committing transactions. In embodiments, the consensus algorithm is a Raft algorithm.

In embodiments, the transactional database enables single phase lock of a database transaction. In embodiments, the transactional database enables single phase commit of a database transaction. In embodiments, the database is an on-premises database for an enterprise. In embodiments, the database is a cloud database. In embodiments, the database is a public cloud database. In embodiments, the database is a private cloud database.

In embodiments, the transactional database is integrated with an e-Commerce system. In embodiments, the transactional database is integrated with a social network system. In embodiments, the transactional database is integrated with an advertising network system. In embodiments, the transactional database is integrated with a communications network. In embodiments, the transactional database is integrated with a location-based services system. In embodiments, the transactional database is integrated with a non-transactional database. In embodiments, the transactional database is integrated with an operating system.

In embodiments, the transactional database uses a disk storage infrastructure. In embodiments, the transactional database uses a storage area network storage infrastructure. In embodiments, the transactional database is integrated with an operating system component for data storage. In embodiments, the transactional database supports a multi-cloud deployment. In embodiments, the transactional database uses data partitioning using a primary key for instance partitioning and uses term partitioning for indexes. In embodiments, the transactional database uses a local storage engine that is implemented as a compressed log-structured merge tree.

In embodiments, a database system for data storage and retrieval includes a transactional database having a distributed data architecture. Queries to the database are expressed in a functional query language that is implemented as an embedded domain specific language within a client driver host file of a client system that accesses the transactional database. In embodiments, the client driver host file is accessed upon initiation of a database function in a software development tool.

In embodiments, a system includes a transaction engine that uses a distributed global log to provide atomicity, consistency, isolation and durability for a plurality of data transactions for a distributed system.

In embodiments, the distributed system is a database having a distributed data architecture. In embodiments, the distributed system is a transactional database. In embodiments, the transactional database uses a functional query language. In embodiments, the distributed system uses a consensus algorithm. In embodiments, the consensus algorithm is a Raft algorithm. In embodiments, the distributed system enables single phase lock of a database transaction. In embodiments, the distributed system enables single phase commit of a database transaction.

In embodiments, a system for data storage and retrieval, includes a distributed system having at least one of a data transaction lock and a data transaction commit that is performed in a single network round trip.

In embodiments, the distributed system is a database having a distributed data architecture. In embodiments, the distributed system uses a global log for data transactions across the distributed system. In embodiments, the distributed system is a transactional database. In embodiments, the transactional database uses a functional query language. In embodiments, the distributed system uses a consensus algorithm to determine whether to lock that database or commit a transaction. In embodiments, the consensus algorithm is a Raft algorithm. In embodiments, the distributed system enables single phase lock of a database transaction. In embodiments, the distributed system enables single phase commit of a database transaction.

In embodiments, a system includes a transactional database having a distributed data architecture with data that are encrypted at rest in memory of the transactional database and during transmission to and from memory locations used by the transactional database.

In embodiments, the transactional database uses a functional query language. In embodiments, the transactional database uses a consensus algorithm for at least one of locking and committing transactions. In embodiments, the consensus algorithm is a Raft consensus algorithm. In embodiments, the transactional database enables single phase lock of a database transaction. In embodiments, the transactional database enables single phase commit of a database transaction.

In embodiments, a system includes a distributed data storage and retrieval system and a temporal storage engine that maintains and indexes an entire history of a database record. The system facilitates access to an event stream of database transactions for a time interval configured to be selected by a user. Access rights to the event stream are independently controlled for each of multiple events within the event stream.

In embodiments, the distributed data storage and retrieval system is a database having a distributed data architecture.

In embodiments, the distributed data storage and retrieval system is a transactional database. In embodiments, the transactional database uses a functional query language. In embodiments, the distributed data storage and retrieval system uses a consensus algorithm. In embodiments, the consensus algorithm is a Raft consensus algorithm. In embodiments, the distributed system enables single phase lock of a database transaction. In embodiments, the distributed system enables single phase commit of a database transaction.

In embodiments, a system includes a distributed system for data storage and retrieval that enables a stateless session and that identifies each data transaction with an access token that closes over a transaction context.

In embodiments, the distributed system is a transactional database having a distributed data architecture. In embodiments, queries for the transactional database are written in a host application language and inherit security features of the host application language. In embodiments, queries for the transactional database execute atomically and on a per-transaction basis. In embodiments, any query semantics of a host application language that are inherently non-scalable are replaced with semantics that are scalable. In embodiments, the distributed system is configured to enable natively geographic indexing of records in the transactional database. In embodiments, the distributed system is configured to enable natively full-text search in the transactional database. In embodiments, the distributed system is configured to enable natively iterative machine learning via the transactional database.

In embodiments, a system includes a distributed data storage and retrieval system using a query language that accepts queries sent as complete transaction objects enabling a single-phase process for reading and writing for the distributed data storage and retrieval system.

In embodiments, the distributed data storage and retrieval system is a database having a distributed data architecture. In embodiments, the distributed data storage and retrieval system is a transactional database. In embodiments, the transactional database uses a functional query language. In embodiments, the distributed data storage and retrieval system uses a consensus algorithm. In embodiments, the consensus algorithm is a Raft consensus algorithm. In embodiments, the distributed data storage and retrieval system enables a single phase lock of a database transaction. In embodiments, the distributed data storage and retrieval system enables a single phase commit of a database transaction.

In embodiments, a system includes a distributed data storage and retrieval system having transactional consistency provided using strict serializability of transactions based on a position of each transaction in a global transaction log.

In embodiments, the distributed data storage and retrieval system is a transactional database. In embodiments, the transactional database uses a NoSQL query language. In embodiments, the transactional database uses a temporal storage engine that permits a user to configure a time interval for storage of transactions. In embodiments, the strict serializability of transactions is provided across multi-key transactions in a globally-distributed cluster of transactional databases each having a distributed data architecture. In embodiments, read-only transactions are serializable. In embodiments, the transactional database includes database drivers that maintain a high watermark of global log position of a last request and that are configured to guarantee a monotonically advancing view of a global transaction order. In embodiments, each data center using the transactional database in a cluster uses a synchronization scheme to share a most recently applied log position among all query coordinators to provide automatically a consistent view across clients. In embodiments, write transactions of the transactional database are restricted to a single logical database. Upon validation of permissions, read-only transactions that recursively span multiple logical databases maintain the same serializability guarantee as single database read-only transactions.

In embodiments, a system includes a distributed data storage and retrieval system having lockless transactional consistency provided using strict serializability based on transaction position in a global transaction log.

In embodiments, the distributed data storage and retrieval system is a transactional database. In embodiments, the transactional database uses a NoSQL query language. In embodiments, the transactional database uses a temporal storage engine that permits a user to configure a time interval for storage of transactions. In embodiments, the strict serializability of the transactions is provided across multi-key transactions in a globally-distributed cluster of transactional databases each having a distributed data architecture. In embodiments, read-only transactions are serializable. In embodiments, the transactional database includes database drivers that maintain a high watermark of global log position of a last request and that are configured to guarantee a monotonically advancing view of a global transaction order. In embodiments, each data center using the transactional database in a cluster uses a synchronization scheme to share the most recently applied log position among all query coordinators, thereby automatically providing a consistent view across clients. In embodiments, write transactions of the transactional database are restricted to a single logical database. Upon validation of permissions, read-only transactions that recursively span multiple logical databases maintain the same serializability guarantee as single database read-only transactions.

In embodiments, a system includes a distributed data storage and retrieval system having transactional consistency provided for database transactions by applying a consensus strategy to database locks.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, a strict serializability is provided across multi-key transactions in a globally-distributed cluster of transactional databases each having a distributed data architecture. In embodiments, read-only transactions are serializable. In embodiments, the transactional database includes database drivers that maintain a high watermark of global log position of a last request and that are configured to guarantee a monotonically advancing view of a global transaction order. In embodiments, each data center using the transactional database in a cluster uses a synchronization scheme to share the most recently applied log position among all query coordinators, thereby automatically providing a consistent view across clients. In embodiments, write transactions of the transactional database are restricted to a single logical database. Upon validation of permissions, read-only transactions that recursively span multiple logical databases maintain a same serializability guarantee as single database read-only transactions.

In embodiments, a system includes a distributed data storage and retrieval system having transactional consistency provided for database transactions by using a strict serializability based on a transaction position in a global transaction log and using optimistic locking for the database transactions.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, the strict serializability is provided across multi-key transactions in a globally-distributed cluster of transactional databases each having a distributed data architecture. In embodiments, read-only transactions are serializable. In embodiments, the transactional database includes drivers that maintain a high watermark of global log position of a last request and that are configured to guarantee a monotonically advancing view of a global transaction order. In embodiments, each data center using the transactional database in a cluster uses a synchronization scheme to share the most recently applied log position among all query coordinators, thereby automatically providing a consistent view across clients. In embodiments, write transactions of the transactional database are restricted to a single logical database. Upon validation of permissions, read-only transactions that recursively span multiple logical databases maintain a same serializability guarantee as single database read-only transactions.

In embodiments, a system includes a distributed data storage and retrieval system including a serializable guarantee provided for a database transaction using a strict serializability based on a transaction position in a global transaction log.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, the strict serializability is provided across multi-key transactions in a globally-distributed cluster of transactional databases each having a distributed data architecture. In embodiments, read-only transactions are serializable. In embodiments, the transactional database includes database drivers that maintain a high watermark of global log position of a last request and that are configured to guarantee a monotonically advancing view of a global transaction order. In embodiments, each data center using the transactional database in a cluster uses a synchronization scheme to share the most recently applied log position among all query coordinators, thereby automatically providing a consistent view across clients. In embodiments, write transactions of the transactional database are restricted to a single logical database. Upon validation of permissions, read-only transactions that recursively span multiple logical databases maintain a same serializability guarantee as single database read-only transactions.

In embodiments, a system includes a distributed data storage and retrieval system in which database transactions are recorded in a global log.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, a strict serializability is provided across multi-key transactions in a globally-distributed cluster of transactional databases each having a distributed data architecture. In embodiments, read-only transactions are serializable. In embodiments, the transactional database includes database drivers that maintain a high watermark of global log position of a last request and that are configured to guarantee a monotonically advancing view of a global transaction order. In embodiments, each data center using the transactional database in a cluster uses a synchronization scheme to share the most recently applied log position among all query coordinators, thereby automatically providing a consistent view across clients. In embodiments, write transactions of the transactional database are restricted to a single logical database. Upon validation of permissions, read-only transactions that recursively span multiple logical databases maintain a same serializability guarantee as single database read-only transactions.

In embodiments, a system includes a distributed data storage and retrieval system in which database transactions are recorded in a global log specific to at least one tenant using the distributed data storage and retrieval system.

In embodiments, the distributed data storage and retrieval system is a transactional database. In embodiments, the transactional database uses a NoSQL query language. In embodiments, the transactional database uses a temporal storage engine configured for a user to configure a time interval for storage of database transactions. In embodiments, a strict serializability is provided across multi-key transactions in a globally-distributed cluster of transactional databases each having a distributed data architecture. In embodiments, the transactional database includes database drivers that maintain a high watermark of a global log position of a last request and that are configured to guarantee a monotonically advancing view of the global transaction order.

In embodiments, a system includes a distributed data storage and retrieval system in which database transactions are recorded in a global log that is partitioned by at least one of a tenant, a policy and a role.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, a strict serializability is provided across multi-key transactions in a globally-distributed cluster of transactional databases each having a distributed data architecture. In embodiments, the transactional database includes database drivers that maintain a high watermark of a global log position of a last request and that are configured to guarantee a monotonically advancing view of the global transaction order.

In embodiments, a system includes a distributed data storage and retrieval system that provides transactional consistency for reads across a plurality of distributed systems using strict serializability based on a transaction position of the reads in a plurality of independent transaction logs for the plurality of distributed systems.

In embodiments, at least one of the distributed systems from the plurality of distributed systems is a transactional database. In embodiments, the transactional database uses a NoSQL query language. In embodiments, the transactional database uses a temporal storage engine configured for a user to configure a time interval for storage of database transactions. In embodiments, the strict serializability is provided across multi-key transactions in a globally-distributed cluster of transactional databases each having a distributed data architecture.

In embodiments, a system includes a distributed data storage and retrieval system that provides transactional consistency across a plurality of distributed databases using a hybrid clock and that includes database transactions that are serialized based on an understanding of the correspondence of clock positions for a plurality of clocks used to log transactions in respective transaction logs for the plurality of distributed databases.

In embodiments, the distributed data storage and retrieval system is a transactional database. In embodiments, the transactional database uses a NoSQL query language. In embodiments, the transactional database uses a temporal storage engine configured for a user to configure a time interval for storage of the database transactions. In embodiments, a strict serializability is provided across multi-key transactions in a globally-distributed cluster of transactional databases each having a distributed data architecture.

In embodiments, a system includes a temporal application programming interface for a distributed data storage and retrieval system configured to accept a user subscribing via the temporal application programming interface to a stream of events relating to a class of instance in the data storage and retrieval system.

In embodiments, the temporal application programming interface is configured to accept a listener that subscribes to events of interest. In embodiments, a table is streamed via the temporal application programming interface to another system. In embodiments, an index is configured in the system to subscribe to the temporal application programming interface. In embodiments, the system includes an application that subscribes to the temporal application programming interface for events that are specified for the application. In embodiments, a stream of events within the scope of a streaming query are provided via the temporal application programming interface with a guarantee of temporal consistency. In embodiments, the distributed data storage and retrieval system is a transactional database. In embodiments, the transactional database is configured to provide a stream of events in response to a query for a specified time interval.

In embodiments, a system includes a transactional database having a distributed data architecture and a row-level access control system that enables a user to enforce security permissions at a level of an individual row of a database record of the transactional database.

In embodiments, the transactional database is configured to facilitate direct access to the database by end users of an application for which the transactional database provides a data handling function. In embodiments, the direct access is configured based on a policy. In embodiments, the direct access is configured for a workload based on a policy.

In embodiments, a system includes a transactional database having a distributed data architecture configured to route transactions for the transactional database based on awareness of data infrastructure capabilities and awareness of quality-of-service requirements for at least one of a tenant, a transaction and a workload using the transactional database.

In embodiments, a system includes a transactional database having a distributed data architecture; and a tenant aware resource scheduler for the transactional database that allocates at least one of a compute resource, a memory resource and an input/output resource among tenants and that tracks a per-tenant resource utilization of the at least one resource.

In embodiments, the tenant aware resource scheduler allocates resources based on at least one indicator of priority. In embodiments, the tenant aware resource scheduler allocates resources based on at least one quota. In embodiments, a system includes an access control system that controls access to resources based on at least one of a policy, a role and a rule.

In embodiments, a system includes a transactional database having a distributed data architecture; and a per-workload resource scheduler for the transactional database that allocates at least one of a compute resource, a memory resource and an input/output resource among workloads and that tracks a per-workload resource utilization of the at least one resource.

In embodiments, the per-workload resource scheduler allocates resources based on at least one indicator of priority. In embodiments, the per-workload resource scheduler allocates resources based on at least one quota. In embodiments, a system includes an access control system that controls access to a resource based on at least one of a policy, a role and a rule that applies to a workload.

In embodiments, a system includes a transactional database having a distributed data architecture; and a policy-aware resource scheduler for the transactional database that allocates at least one of a compute resource, a memory resource and an input/output resource within the distributed data architecture based on a policy and that tracks a resource utilization of at least one resource.

In embodiments, the at least one resource is allocated based on at least one indicator of priority. In embodiments, the at least one resource is allocated based on at least one quota. In embodiments, a system includes an access control system that controls access to a resource based on at least one of a policy, a role and a rule.

In embodiments, a system includes a transactional database having a distributed data architecture; and a temporal storage engine of the transactional database having a configurable retention window that maintains an entire history of a record and an index for a history of the record.

In embodiments, a system includes a transactional database having a distributed data architecture with a temporal storage engine of the database that maintains and indexes the entire history of a record and facilitates access to an event stream of events within a history for a time interval selected by a user.

In embodiments, a system includes a query language for the transactional database configured for a user to specify a time interval for a query and the transactional database provides an event stream that responds to the query for the specified time interval.

In embodiments, a system includes a transactional database having a distributed data architecture using an object-relational data model that is organized into instances, classes, databases and keys. The object-relational data model is semi-structured and schema-free.

In embodiments, the data model includes a defined superset of relational, document, object-oriented, and graph paradigms. In embodiments, the transactional database includes records that are inserted into the transactional database as semi-structured documents defined as instances. In embodiments, the instances are grouped into classes. In embodiments, the classes are grouped into databases. In embodiments, the transactional database includes access is controlled by keys. In embodiments, the transactional database includes queries parameterized as functions. In embodiments, the transactional database includes derived relations that are constructed with indexes.

In embodiments, a system includes a transactional database having a distributed data architecture that uses an object-relational data model and derived relations for the object-relational data model are constructed as indexes for the transactional database.

In embodiments, the object-relational data model includes a defined superset of relational, document, object-oriented, and graph paradigms. In embodiments, the transactional database includes records inserted as semi-structured documents defined as instances. In embodiments, the instances are grouped into classes. In embodiments, the classes are grouped into databases. In embodiments, access to the transactional database is controlled by keys. In embodiments, queries for the transactional database are parameterized as functions.

In embodiments, a system includes a transactional database having a distributed data architecture, that uses an object-relational data model having constraints that are enforced using indexes for the transactional database.

In embodiments, the object-relational data model includes a defined superset of relational, document, object-oriented, and graph paradigms. In embodiments, the transactional database includes records inserted as semi-structured documents defined as instances. In embodiments, the instances are grouped into classes. In embodiments, the classes are grouped into databases.

In embodiments, access to the transactional database is controlled by keys. In embodiments, queries for the transactional database are parameterized as functions. In embodiments, the transactional database includes derived relations constructed with indexes.

In embodiments, a system includes a transactional database having a distributed data architecture, including a query language for the transactional database that is mediated by a plurality of drivers that publish domain specific embedded application language output from the transactional database.

In embodiments, a system includes a transactional database having a distributed data architecture that implements database drivers that publish in embedded domain-specific languages for a plurality of application languages.

In embodiments, a system includes a transactional database having a distributed data architecture, that implements a query language enabling multiple record encapsulation and that allows a single request query to encapsulate a transaction that spans multiple records.

In embodiments, a system includes a transactional database having a distributed data architecture that implements query semantics that requires non-primary-key access to be backed by an index.

In embodiments, a system includes a transactional database having a distributed data architecture, including identity management performed by a service that issues a token to an authenticated user. The token allows the user to perform further actions with the transactional database.

In embodiments, the service that issues the token is an internal service of the transactional database. In embodiments, the service that issues the token is a third-party service that is performed externally from the transactional database.

In embodiments, a system includes a transactional database having a distributed data architecture with access control that uses key-based role assignment to limit row-level access to one or more data records in the transactional database.

In embodiments, the access control includes row-level security managed through assignment of identities. In embodiments, the transactional database includes access rights for which decisions for at least one of a user, a role and a group, are implemented by assigning access control query expressions to access control lists. In embodiments, an identity of an actor performing a database transaction is accessible within the context of a stored procedure.

In embodiments, a system includes a transactional database having a distributed data architecture including transactions that are tracked and reported using a global transaction log.

In embodiments, the transactional database deploys a temporal storage model that preserves the previous contents of all records within user-configured retention periods. In embodiments, the transactional database includes an application that tags a transaction with actor information and access historical data by referencing database instance versions involved in a transaction.

In embodiments, a system includes a transactional database having a distributed data architecture, including administrative and application transactions that are logged using a global transaction log.

In embodiments, the transactional database deploys a temporal storage model that preserves the previous contents of all records within user-configured retention periods. In embodiments, the transactional database includes an application that tags a transaction with actor information and access historical data by referencing database instance versions involved in a transaction.

In embodiments, a system includes a transactional database having a distributed data architecture using encryption for data at all points of a database transaction.

In embodiments, the transactional database includes traffic within a database cluster that is encrypted via SSL. In embodiments, the transactional database includes traffic on public interfaces to the transactional database that is encrypted via SSL. In embodiments, the transactional database includes applications interacting with the transactional database that are authenticated via public/private key pairs. In embodiments, at least one operating system function of the transactional database is used to secure data with at least one of a data rest, log information, and private keys. In embodiments, the at least one operating system function is file encryption.

In embodiments, a system includes a cluster of transactional databases, each having a distributed data architecture. The system includes a cluster topology configuration for a database in the cluster of transactional databases serves as a query coordinator, data replica and log replica for the databases. The configuration topology is automatically derived by the system.

In embodiments, a consistent cluster state is maintained for the transactional databases in the cluster.

In embodiments, a system includes a cluster of transactional databases, each having a distributed data architecture. At least one transactional database member of the cluster serves as a query coordinator, a data replica, and a log replica. Predicates are automatically pushed to replicas of a database cluster.

In embodiments, each member of the cluster serves as a query coordinator, a data replica and a log replica.

In embodiments, a system includes a transactional database having a distributed data architecture including data writes that are enabled via a data structure that is modified in place for a local storage engine and that is implemented as a compressed log-structured merge tree.

In embodiments, transactions are committed in batches to a global transaction log. In embodiments, transactions are committed as a write-ahead log. In embodiments, the transactional database is part of a cluster in which at least one transactional database is a replica. The replica takes the global transaction log and writes transactions based on the log atomically in bulk to the replica. In embodiments, the transactional database uses a temporal data model that is composed of immutable versions, such that synchronous overwrites are avoided.

In embodiments, a system includes a transactional database having a distributed data architecture, and a tenant-aware resource manager that uses a process scheduler to dynamically allocate resources to enforce a quality of service policy for the transactional database.

In embodiments, a system includes a query planner for the database that evaluates transactions as a series of interleaved and potentially parallelizable compute and input/output sub-queries and guarantees that execution yields predictable and granular barriers between transactions.

In embodiments, a system includes a transactional database having a distributed data architecture and background query tasks that are managed by a journaled, topology-aware task scheduler for the transactional database.

In embodiments, tasks are limited to one instance across a cluster. In embodiments, tasks are limited to one instance per database. In embodiments, tasks are assigned to a specific data range. In embodiments, a system includes an executing node for a task that is data replica for the specific data range. In embodiments, an execution state of each task of the background query tasks is persisted in a consistent metadata store and scheduled tasks run in a node-agnostic manner. In embodiments, when a node fails, its tasks are at least one of automatically reassigned to other valid nodes, restarted, or resumed. In embodiments, when a node is removed from a cluster, its tasks are at least one of automatically reassigned to other valid nodes, restarted, or resumed. In embodiments, a task execution throughput is controlled by a resource scheduler on at least one of a per-tenant, per-user, and per-workload basis. In embodiments, a task execution for work not associated with a specific tenant is scheduled at low priority, allowing the task to proceed as idle resources allow it.

In embodiments, a system includes a transactional database having a distributed data architecture, a consistency mechanism and a process scheduler that are provided ensure coherent state consistency across multiple topologies for the transactional database.

In embodiments, a system includes a transactional database having a distributed data architecture; and a management platform to manage a cluster of multiple configured transactional databases. The multiple databases within the cluster act as a single system.

In embodiments, the management platform automatically configures the multiple transactional databases. In embodiments, cluster management capabilities are implemented using an application programming interface. In embodiments, a transactional database endpoint having a single identifier is provided as a connection to an enterprise information technology system, and the resources for the endpoint are managed by the management platform. In embodiments, the identifier for the endpoint is a DNS name. In embodiments, resources for the endpoint are dynamically scaled under control of the cluster management platform to satisfy demand by the enterprise information technology system.

In embodiments, a system includes a cluster of transactional databases, each having a distributed data architecture. The configuration of the cluster of transactional databases is automatically executed by a database upon specification of a configuration by an operator.

In embodiments, the operator specifies at least one parameter of configuration for the cluster of transactional databases and the system automatically determines and executes the steps required to configure the cluster of transactional databases. In embodiments, upon loss of a data storage resource during configuration of the cluster of the transactional databases, the system is configured to continue to operate in a fault tolerant manner.

In embodiments, a system includes an operational database that is automatically configured to be deployed on a cloud infrastructure without requiring configuration for specific infrastructure capabilities of a type of cloud on which the operational database is deployed.

In embodiments, a system includes a transactional database having a distributed data architecture configured to track and meter transactions automatically based on a use of resources by at least one of an application using a resource, a workload using a resource, a tenant using a resource, a user using a resource, and a key associated with a use of a resource.

In embodiments, a system includes a transactional database system for data storage and retrieval, the system comprising: a transactional database having a distributed data architecture. The transactional database uses a semi-structured document model that adapts to a data model for a software application, such that the transactional database is configured to enable database support for a software application independent of whether the software application uses an object-oriented data model or a relational data model.

In embodiments, the transactional database is a NoSQL database.

In embodiments, a system includes a transactional database having a distributed data architecture and a routing layer within which routing of data transactions occurs with awareness of capabilities of a data center at which at least a portion of the distributed data architecture is deployed.

In embodiments, the database system includes a database having a query engine that enables multiple query models, the query models including at least two query models selected from among SQL-format queries, noSQL format queries, graph-based queries, geospatial queries, and analytic-format queries, key/value queries, document queries, temporal queries, and search queries; and a set of database functions configured to respond to queries against the database delivered via the query engine.

In embodiments, the database provides a row-level security access feature. In embodiments, the database provides a row-level handling of identity. In embodiments, the database provides a row-level handling of authentication. In embodiments, the database has an elastic architecture. In embodiments, the database enables masterless configuration and operation. In embodiments, the database enables recursive multi-tenancy configuration and operation. In embodiments, the database is configured to be replicated to multiple geographically diverse data centers or cloud infrastructure providers.

In embodiments, the database is deployed with a relational query language. In embodiments, the database is provided with process isolation capabilities. In embodiments, the database is deployed with recursive scheduling to enable process isolation for the database. In embodiments, the database is deployed with recursive implementation of completely fair queuing in connection with process isolation. In embodiments, the database is deployed with dynamic resource scheduling including across a database cluster of the database.

In embodiments, the database is deployed with dynamic resource scheduling on a query-by-query basis. In embodiments, the database is deployed with dynamic resource scheduling on a user-by-user basis. In embodiments, the database is deployed with a distributed storage layer. In embodiments, the distributed storage layer is deployed with a transaction resolution algorithm. In embodiments, the database is distributed and the database is deployed with a replication algorithm using a replication log that replicates information to different storage nodes of a distributed storage layer.

In embodiments, the database is deployed with an on-disk storage engine. In embodiments, the database is provided having per query quality-of-service management. In embodiments, the database enables a native running of background analytic tasks in the database. In embodiments, the database is an operational database and a direct acyclic analytic task graph is operated against the database. In embodiments, the database includes columnar analytics capabilities. In embodiments, the database enables a streaming of queries.

In embodiments, the database is an on-premises database for an enterprise. In embodiments, the transactional database is integrated with a multiple user gaming system. In embodiments, the transactional database is integrated with a financial network system. In embodiments, the transactional database is integrated with a at least one financial ledger associated with the financial network system. In embodiments, the transactional database is integrated with an identity management system. In embodiments, the transactional database is integrated with a customer relations management network. In embodiments, the transactional database is integrated with a location-based services system.

### BRIEF DESCRIPTION OF THE FIGURES

FIG. 1A and FIG. 1B are diagrammatic views that each depicts methods and system of the various embodiments of the transactional database in accordance with the present disclosure.

### DETAILED DESCRIPTION

### Overview

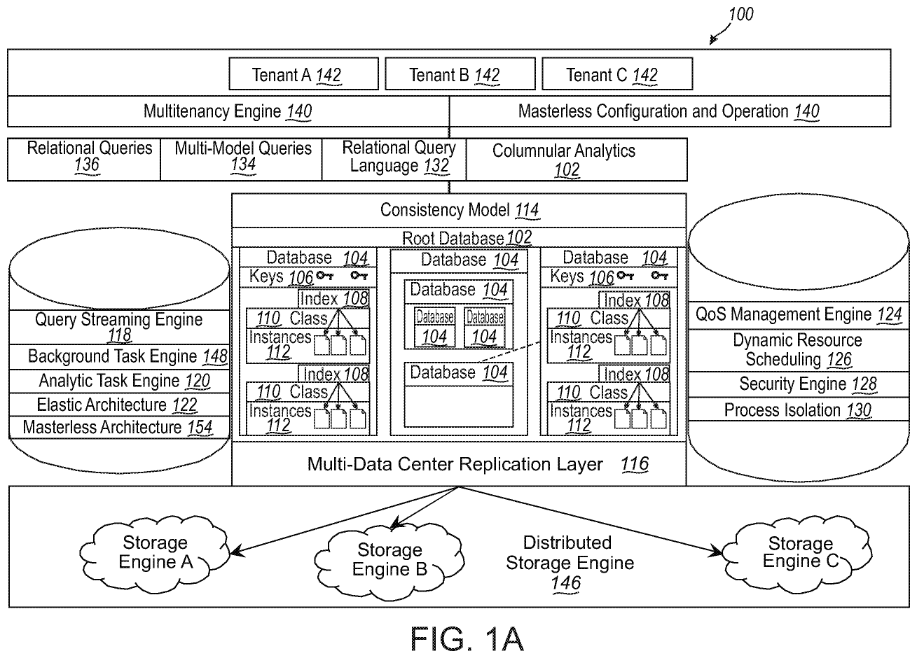

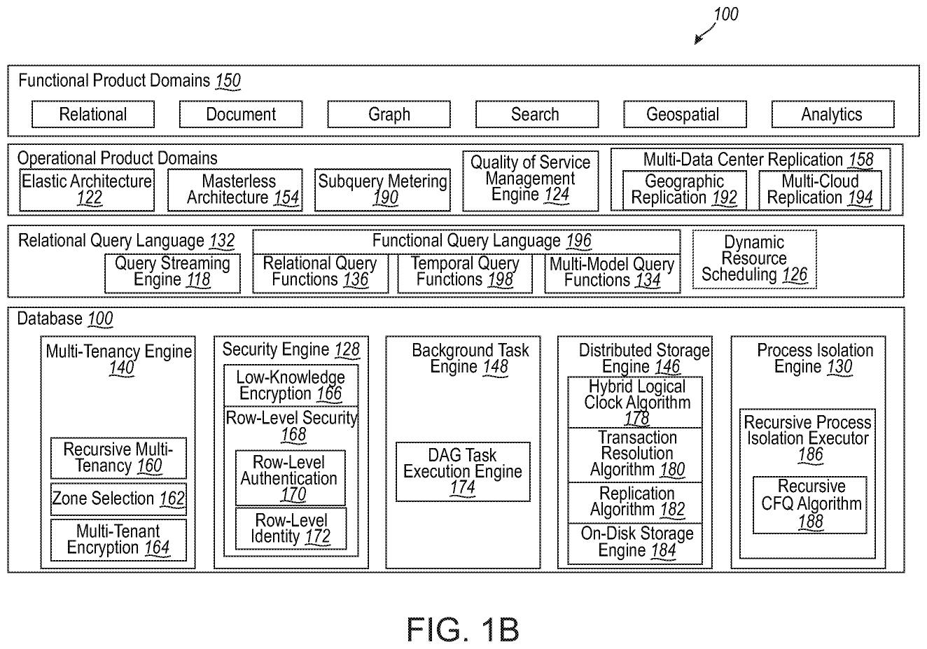

FIGS. 1A and 1B depict a database 100 according to an exemplary and non-limiting embodiment. The database 100 may include a root database 102. The root database 102 may include additional databases 104. The additional databases 104 may include keys 106, indexes 108 and classes 110. The additional databases 104 may include other additional databases 104 arranged in a hierarchy, for example. The additional databases 104 may connect to other additional databases 104. The classes 110 may include instances 112. The indexes 108 may point to the instances 112.

In embodiments, the database 100 is an operational database, containing data relevant to the ongoing operations of an enterprise, including data that continually changes as updates are made to reflect recent events and transactions and encompassing features that enable dynamic management and processing of data in real time. In embodiments, the database 100 is adaptive, encompassing a set of capabilities that enable the database 100 to be adapted to the needs of a particular enterprise or environment, such as be adapted for varying storage environments (including distributed and cloud storage environments), adapting to use of varying forms of queries, and adapting to enable varying applications and services.

The database 100 may include a consistency model 114, a multi-data center replication layer 116, a query streaming engine 118, a background task engine 148, an analytic task engine 120, an elastic architecture 122, a QoS management engine 124, dynamic resource scheduling 126, a security engine 128 and a process isolation engine 130. Process isolation may include a recursive process executor 186 and a recursive CFQ algorithm 188. The background task engine 148 may include a DAG task execution engine 174. The security engine 128 may include low-knowledge encryption security 166 and row-level security 168. Row-level security 168 may include row-level authentication 170, row-level identity 172 and the like.

The consistency model 114 may connect to a relational query language 132. The relational query language 132 may include multi-model query functions 134, relational query functions 136 and the like. The relational query language 132 may also support columnar analytics system 138. In embodiments, the database 100 may include the columnar analytics system 138.

The columnar analytics system 138 may provide functionality around materialized views similar to that provided in online analytics databases. This may comprise various forms of intermediate data between the operational data used to operate an enterprise and streams of analytical data.

The database 100 may support a multi-tenancy engine 140 and masterless configuration and operation. The multi-tenancy engine 140 may enable multiple tenants 142 to access the database 100. The multi-tenancy engine 140 may include recursive multi-tenancy 160, zone selection 162 and multi-tenant encryption 164.

In embodiments, a zone selection system 162 is provided for a distributed database. Zone selection provides the ability to dynamically choose which physical data centers a logical data set should be replicated to. For example, European users can have their data stored in Europe, etc. In conventional commercially available systems, there is no way to do that within the database. Instead, operators have to deploy the database at the operational level and set up a new database cluster. To achieve geographic selection, users must deploy at the operational level and set up a new DB cluster (a capability that is not provided at all in most systems).

A multi-data center replication layer 116 may connect to storage resources that may be stored within a distributed storage engine 146. The distributed storage engine 146 may support multi-data center replication 176 and include distributed storage layer algorithms. Distributed storage layer algorithms may be a hybrid logical clock algorithm 178, transaction resolution algorithm 180, replication algorithm 182 and the like. The distributed storage engine 146 may also include an on-disk storage engine 184.

The database 100 may support functional product domains 150. The functional product domains 150 may include relational domains, document domains, graph domains, search domains, geospatial domains, and the like.

The database 100 may support operational product domains 152. Operations product domains 152 may include the elastic architecture 122, masterless architecture 154, QoS management 156, subquery metering 190 and multi-data center replication 158.

The database 100 may record machine resource consumption metrics on a per-query and per-user basis. These metrics may be recorded in real time and used to inform the dynamic resource scheduling 126 and enforce machine resource quotas. These metrics may be exposed to developers in the form of logs, graphs, and headers.

Multi-data center replication 158 may be supported by the multi-data center replication layer 116 and include geographic replication 192, multi-cloud replication 194 and the like.

In embodiments, the database may include the capability for user-defined sorted indexes. This may include modeling page ranks, leaderboards, and unique lists of records by update time, and other ranking semantics in a declarative way without manipulating the valid time of records.

### Foundations

The database 100 may be composed of several interrelated subsystems. These subsystems may include a functional, relational query language 132 based on functional programming paradigms, a strongly consistent transaction resolution engine, an on-disk storage engine 144, a tenant-aware resource scheduler, row-level security engine, identity, and isolation management, a background task scheduler, and data center-aware routing layer.

The database 100 may support the elastic architecture 122, masterless configuration and operation and multi-tenancy configuration and operation. The database 100 may be globally replicated.

A functional, relational query language 132 may be based on Lisp and unify relational, document, graph, temporal, search, geospatial, analytical, and batch processing access patterns, while restricting their execution contexts, increasing flexibility, ease-of-use, and safety. The relational query language 132 may enable an operator to perform the relational query functions 136.

In embodiments, a unified architecture is provided for the database 100. Data storage is enabled for data types that support a variety of query models, including any of search, graph, temporal, geospatial, key/value, document, and analytics queries. Further, a unified query language is provided for enabling access to the functionality of each of the query models. As a result, users, such as enterprises are not constrained in how they need to store data just to support the use of a particular query model; instead, storage can be undertaken without concern for the query model, and any and all of the query models can be used.

The multi-data center replication layer 116 may include a strongly consistent transaction resolution engine. A strongly consistent transaction resolution engine may be used, such as based on Calvin and backed by a distributed global log to maximize correctness and ease-of-use without limiting scalability. In embodiments, the transaction resolution algorithm is based on the Calvin algorithm, augmented using Raft logs to replicate historical information stored by the database, so that distributed storage nodes can pull reads from points in time in the past without requiring coordination across the cluster. Among other benefits, this enables strongly consistent, full transaction reads, without having to cross the global Internet like other systems, such as CockroachDB™ have to do. In embodiments, a lockless, timestamp-based replication approach is implemented with series of time-stamped, isolated snapshots that are undertaken and then serialized as needed by re-ordering the snapshots.

The on-disk storage engine 144 may be based on log-structured merge trees (similar to Google BigTable™) and maximize IO throughput.

A tenant-aware resource scheduler, which may operate similarly to an operating system kernel, may fairly allocate compute, memory, and IO resources to competing applications and workloads based on priorities and quotas. A tenant-aware resource scheduler may support the multi-tenancy engine 140 in the database 100. The multi-tenancy engine 140 may support the use of a single database 100 by multiple tenants 142. The multi-tenancy engine 140 may also support recursive multi-tenancy.

Row-level security, identity, and isolation management, which may be similar to those similar functions of a file system, may transparently protect data access.

A background task scheduler, which may operate similarly to Apache Hadoop YARN, for example, may enable asynchronous execution of long-running jobs. In embodiments, the database enables the native running of background analytic tasks in the database. Users can run analytics in an asynchronous way, such as similar to a MapReduce system (like Hadoop™ or Spark™), but the tasks can natively in the operational database. In embodiments, the database enables the ability to execute a directed acyclic graph of tasks (such as analytics tasks) as a process against the operational data of an enterprise that is stored in the database.

A data center-aware routing layer, which may operate similarly to a software load balancer, for example, may minimize effective latency and maximize global availability.

In the same way that an operating system dynamically allocates machine resources to a prioritized and potentially conflicting set of users and processes, the database 100 may dynamically allocate globally distributed data resources to a prioritized and potentially conflicting set of applications, users, and workloads.

In embodiments, the database 100 may be implemented as a transactional NoSQL database. The database 100 may have an architecture that may have functional parity with SQL-based databases and a feature set that encompasses SQL and NoSQL database features. This ensures that the database 100 delivers on the enhanced productivity promise of the NoSQL while incorporating the safety and correctness characteristics of SQL. The database 100 may be implemented in Scala and Java, and may run on the Java Virtual Machine (JVM) on all major operating systems.

### Data Model

Modern applications no longer interact exclusively with tabular or relational data. Adaptability requires supporting multiple data structures within the same system. With this requirement in mind, the database 100 may implement a semi-structured inheritance-free object-relational data model, which may be a strict superset of the relational, document, object-oriented, and graph paradigms. The semi-structured model may be shown to adapt well to existing application data as it may evolve over time and may eliminate the object-relational impedance mismatch typically experienced when working with SQL systems.

In the database 100, records may be inserted as semi-structured documents called the instances 112, which may include recursively nested objects and arrays as well as scalar types.

The instances 112 may be grouped into the classes 110, which may be similar to tables in a relational database. Full or partially shared schema within a class may be optional, not mandatory.

The classes 110 may be grouped into the additional databases 104. These additional databases 104 may recursively contain other additional databases 104. Additional databases 104 may be grouped into the root database 102.

Database access may be controlled by the keys 106. The keys 106 may be credentials that identify the application requesting access and close over a specific database context. The keys 106 may be assigned priorities, resource quotas, and access control roles.

Relations and views may be built with the indexes 108. An index may be a transformation of a set of input instances 112 into one or more result sets composed of terms and values. The indexes 108 may be expressed as partially applied queries and may transform, cover, and order their inputs, enforce unique constraints, and read dependent data. The indexes 108 may be referenced explicitly in query expressions; to avoid performance discontinuities, an optimizer may not make index application decisions on behalf of the developer.

Schemas may be composed of structural or dependent types and may be optionally enforced by declaring validations. Validations may apply partially, applied query expressions to inserts, updates, deletes and the like.

Queries may be parameterized as functions, in order to share logic across applications, abstract logic from applications that may be difficult to upgrade in place or create custom security models.

The query streaming engine 118 may stream queries. Queries may be streamed as properties. The database 100 may allow an application to register interest in a query and receive update events in real-time.

In embodiments, the query streaming engine 118 may participate in a database's distributed storage engine 146. By doing so streaming queries may receive consistent updates and may implement a variety of transactional isolation levels.

In embodiments, a recursive schema may be used, with multiple levels of logical database nesting.

In embodiments, the database 100 may implement a new relational query language 132 based on Lisp that is functional, flexible, and type safe. The relational query language 132 may allow an operator to execute the multi-model query functions 134, the relational query functions 136 and the like. Interaction with the relational query language 132 may be mediated by domain specific languages (DSL's), which may be implemented via drivers for different application languages. A relational query language may include a functional query language 196. A functional query language 196 may support the multi-model query functions 134, the relational query functions 136, temporal query functions 198 and the like.

A developer using the database 100 may write what appears to be application-native code in a functional style within a transaction context. A single request may encapsulate a transaction that spans multiple records. A driver of the database 100 may reflect on the native expression and serialize it to the internal wire protocol. The transaction may then be transmitted and executed atomically by the database. The relational query language 132 may unify relational, document, graph, temporal, analytical and batch processing access patterns while restricting their execution contexts, increasing flexibility, ease-of-use and safety. A relational query model may provide components necessary to manage graphs, documents, and the like. The relational query language 132 may support query models. Query models may emerge from underlying architecture and implementation choices.

### Implementation

The relational query language 132 of an adaptive operational database may make a number of tradeoffs designed to increase safety, predictability, and performance.

Queries may be written in the host application language and inherit its safety mechanisms, excluding the need for a string evaluation step that may lead to injection attacks.

Not all query functionality may be permitted in all execution contexts. For example, in a synchronous interface, table scans may be disallowed, and all of the indexes 108 must be explicitly referenced. This may guarantee a consistent and scalable performance profile for customer-facing workloads.

However, in the asynchronous interface for a task scheduler, table scans may be permitted, and the planner may choose to implicitly take advantage of an index if it exists. This may allow for more flexibility in the construction and optimization of analytics and machine-learning tasks. Analytics tasks may be constructed and optimized by the analytic task engine 120. Analytics tasks may include the columnar analytics tasks 138.

Synchronous queries (and all subqueries in asynchronous queries) may execute atomically and transactionally. Session transactions may not be supported. Because the database receives the entire transaction before constructing the execution plan, execution may proceed with maximum parallelization and data locality. Optimization opportunities like predicate pushdown apply universally and predictably.

The database 100 may provide stable cursor-based paging, instead of the offset/limit style of SQL, for example.

Database sessions may be stateless; every transaction may be identified with an access token that may close over the transaction context and may include a transaction high-watermark as well. This may allow the database cluster to dynamically route transactions to the least loaded nodes while maintaining strict serialization. This ensures that connections may be very low overhead and suitable for ephemeral use, which can be shown to make access from serverless applications or embedded devices practical.

These improvements may be difficult or impossible in legacy query languages because they require restricting the language, not extending it, damaging standards compatibility.

The extensibility of the relational query language 132 of the database 100 may allow the database to incorporate an effectively unlimited number of additional functions common to other data domains such as geographic indexing, full-text search, iterative machine learning and the like, without the burden of grafting custom syntax and extensions onto a closed standard model.

By way of example, the following transaction, written in Scala, inserts a blog post with case-insensitive tags:

```
Create(Ref(“classes 110/posts”),
      Obj(“data” -> Obj(“title” -> “All Aboard”,
            “tags” -> Map(Lambda { tag => Casefold(tag) },
                  Arr(“Ship”, “Travel”)))))
```

This read-only transaction looks up posts by the “travel” tag in an index:

Paginate(
Match(Ref(“indexes 108/posts_by_tags”), “travel”)))

This read-only transaction performs a join of blog posts and inbound references to them by primary key:

```
Paginate(
      Join(Match(Ref(“indexes 108/posts_by_tags”),”travel”),
            Ref(“indexes 108/linkbacks_by_post”))))
```

### Native Multi-Tenancy

In embodiments, the database may support native multi-tenancy capabilities. In embodiments, the database may allow a single cluster, operated by a single operations team, to support any number of fully isolated workloads at the maximum theoretical degree of utilization. The database may enable multi-application or isolated workloads within a single enterprise. This may include providing such capabilities for cloud and premises deployments (such as allowing a multi-tenant system within a cloud account). There may be no meaningful practical limit to the number of logical databases within a cluster or an account. Global utilization may be maximized, such that resources are not unused if any queries are outstanding. The implementation of native multi-tenancy capabilities may be fully enabled in the core database. In embodiments, these capabilities may be provided by, for example, allowing logical databases to recurse, that is, to contain other databases. This means a “tenant” and “logical database” are essentially treated as the same thing with respect to the database platform, and references to logical databases throughout this disclosure should be understood to encompass ones that are defined and used for multi-tenant situations. An API for the database can support multi-tenancy this by, for example, providing an “admin” key type, such as one that has the same permissions as a server key and that can have permission to add/remove keys and add/remove child tenants (and/or child-databases). In embodiments, schema manipulation may be separated out of the key's permissions. In embodiments, the key for any query may close over the scope of the root database 102, which may serve as the account for resource debits as well.

Database recursion may be implemented as follows. Since all logical databases can exist in the same unique ID space, the size of primary keys does not need to be increased. Additionally, keys close over their logical database, so a recursive lookup is not required for single-database queries. The vast majority of the implementation can be agnostic to the existence of database recursion. A generically recursive system may be more straightforward to implement than a specialized system that makes assumptions about the maximum depth of the tenancy tree.

For global lookup, keys may be the primary entry point into the system. As such, while they belong to a specific scope, they may also need a global identifier that can be given to a client and used for lookup. Similarly, a scope's owner (its database) may need to be found via the scope.

A key's global identifier cannot necessarily be trusted to be unique. As such, looking up a key by its global identifier may return a set of instances. Matching a secret parameter may reveal the proper instance to use. Scope identifiers may be internal only and can thus be ensured to be unique. Looking up a database by its scope identifier should yield a single instance. An error will be returned if the scope identifier is not globally unique.

An admin key may be considered the “root key” of its scope. As such it may be permitted to create keys of any role (admin, server, client) for its own tenant or for any child tenants. It may also be permitted to create and configure child tenants.

The data model for multi-tenancy may be configured to support other features, such as QoS features, such as for quotas and their associated telemetry.

### Temporality

Typically, historical data cannot be accessed in real-time or with the same query capabilities as current data. In order to support fundamental interaction patterns with no additional application complexity, all records in the database 100 (including schema records) may be temporal.

When the instances 112 are changed, their prior contents are not overwritten; instead, a new instance version at the current transaction timestamp may be inserted into the instance history, either as a create, update, or delete event. The database 100 may support configurable retention policies on a per-class and per-database basis.

All reads, including index reads, joins, or any other query expression in the database 100, may be executed consistently at any point in the past or transformed into a change feed of events between any two points in time. This may be useful for auditing, rollback, cache coherency, syncing to second systems, and may form a fundamental part of an adaptive operational database's isolation model.

Privileged actors may manipulate historical versions directly to fix data inconsistencies, scrub personally identifiable information, insert data into the future, or perform other maintenance tasks.

A temporal database may be distinguished from a time-series database. Time-series databases are optimized for low-latency recording of values that change over time: often handling sampled data like temperature, stock price, or fuel consumption data. They are also useful for counting and aggregating events, such as the number of cars that pass over a road, the number of votes cast, the number of “likes” on a social media post, or the like. As such they are optimized heavily for writing numeric data. To achieve this optimization, time-series databases typically support only very simple transaction patterns that do not involve multiple keys, types other than numbers, large data sizes, or indexes. They make it easy to study aggregated trends across time periods, but complex business transactions remain the domain of operational databases, and complex analysis remains the domain of columnar or map/reduce analytics systems. Conventional time-series databases typically support only very simple transaction patterns.

By contrast, a temporal database as described herein, rather than merely recording sampled numeric data ordered by time, tracks every change to business data within a retention period. In other words, it is a historical database. For example, as transactions are processed, they append, rather than overwrite, previous states. As a result, the previous state of the world can be viewed by running a complex query with a timestamp in the past.

In embodiments, the database platform described herein may provide a temporal database, which may comprise a solution for various time-series use cases involving values that change over time, such as data center operational metrics, as well as higher level business transaction and analytics solutions.

In embodiments, all records (including schema) may be temporal and may support configurable retention policies. When records are updated or deleted, their prior contents are not overwritten; instead, a new immutable version at the current transaction timestamp may be inserted into the instance history, either as a create, update, or delete event. All transactions, including transactions involving indexes, can be executed at a point in the past (or the future), or transformed into a change feed of the events between any two points in time. In embodiments, all transactions can be executed at any point in the past or transformed into a change feed.

This is extremely useful for auditing business transactions, undoing developer mistakes or security breaches (even deleting an entire database can be reversed), syncing partially-connected clients like mobile phones, constructing activity feeds, keeping analytics systems up-to-date and supporting the isolation model described herein.

One way temporality helps development efforts is through ‘snapshots.’ If one needs to ask questions about the state of an entity at a specific time, or within a date range, such as, for example, when building a ‘Friend Locator’ app, snapshot instances can be helpful. In an example, users of the app may check in to update their current location, which results in the database setting a field on the user instance, such as the following:

```
update(ref(class(‘users’), 123), params: { data: { location: ‘Sydney’ } })
{
    “ref”: { “@ref”: “classes/users/123” },
    “ts”: <clock_time>,
    “data”: {
        “location”: “Sydney”
    }
}
```

To show the user where the user was at the same time last week, the app may simply retrieve the user record using a timestamp in the past, such as with the following:

```
get(ref(class(‘users’), 123), ts: <week ago>)
{
    “ref”: { “@ref”: “classes/users/123” },
    “ts”: <week_ago>,
    “data”: {
        “location”: “San Francisco”
    }
{
```

Since the database maintains temporality even in indexes, one can query an index for where all of a user's friends were in the past, such as with the following:

```
paginate(match(index(‘friends_by_location’), ref(class(‘users’), 123)))
{
    “data”: [
          [“Austin”, { “@ref”: “classes/users/789” }],
        [“Los Angeles”, { “@ref”: “classes/users/234” }],
        [“New York”, { “@ref”: “classes/users/456” }],
        [“Oakland”, { “@ref”: “classes/users/567” }
    ]
}
paginate(match(index(‘friends_by_location’), ref(class(‘users’),
123)), ts: <week ago>)
{
    “data”: [
        [“Chicago”, { “@ref”: “classes/users/456” }],
        [“Fremont”, { “@ref”: “classes/users/789” }],
        [“Houston”, { “@ref”: “classes/users/567” }],
        [“San Diego”, { “@ref”: “classes/users/234” }
    ]
}
```

Change feeds can be used, such as, for example, to provide a user a journal view of where the user has been recently. The events function can take temporality beyond snapshots. The events view returns a change feed of how data the result set changed over time, such as in the following:

```
map(paginate(ref(class(‘users’), 123), after: <week_ago>, events: true))
do |event|
    get(select(‘resource’, event), select(‘ts’, event))
end
{
    “data”: [
        {
            “ref”: { “@ref”: “classes/users/123” },
            “ts”: <week_ago>,
            “data”: {
                “location”: “San Francisco”
            }
        },
            “ref”: { “@ref”: “classes/users/123” },
            “ts”: <day_ago>,
            “data”: {
            “location”: “Melbourne”
            }
        },
        {
            “ref”: { “@ref”: “classes/users/123” },
            “ts”: <minute_ago>,
            “data”: {
                “location”: “Sydney”
            }
        }
    ]
{
```

Time-series databases only store a sequence of numeric values. They cannot respond to queries more sophisticated than a simple list or aggregation of the numeric values they store. The temporal database provided herein encodes temporality into the transactional query engine of the database. For this reason, it is vastly more powerful and general in purpose than a conventional time-series database. In fact, a time-series database can be created within a temporal database, such as by doing a rollup aggregation, either in the temporal database or at the application level using data from the temporal database.

As noted, above, in embodiments, users of the database may wish to have historical access to data, such as for enabling features like audit logs, “undo,” capabilities, social timelines, and data model migration, all of which are supported by temporal features. Historical access features may address requirements for standardized rendering of set and instance history, as well as generalized query support for transforming non-temporal (i.e., “snapshot”), read-only queries into temporal queries.

In embodiments, an instance events structure for version history looks like the following:

```
{
    “resource”: ref,
    “action”: [ “create” | “delete” ],
    “ts”: timestamp
}
```

There are several notable disadvantages to this format: The diff at the given “ts” is stored on disk, but unavailable to the user without issuing another query. The action element overloads the “create” terminology to indicate both creation of a previously missing instance, and an update to an existing instance. To resolve these issues, instance events may instead be rendered as follows:

```
{
    “instance”: ref,
    “action”: [ “create” | “update” | “delete” ],
    “ts”: timestamp,
    “data”: diff
}
```

The value of “action” thus contains three variants with the addition of an “update” to indicate the existence of a “create” on this instance prior to the timestamp (with no intervening “delete”). The value of data will contain the difference at a timestamp, as follows:

Action: data

Create: instance data at ts

Update: diff from is −1 to is

Delete: null

An events structure for set history may look like the following:

```
{
    “resource”: ref,
    “action”: [ “create” | “delete” ],
    “ts”: timestamp,
    “values”: tuple
}
```

As with instance events, above, this structure has several issues. The element for “values” is an ad-hoc addition and, in many indexes, duplicates the value of “resource”. In indexes, which do not cover the source instance's ref, rendering “resource” is unnecessary and misleading. To better describe set events, embodiments may render set events as follows:

```
{
    “instance”: ref,
    “action”: [ “add” | “remove” ],
    “ts”: timestamp,
    “data”: tuple,
}
```

The tuple, as noted with respect to the index configuration, will be rendered under “data”, replacing the “values” key. The reference of the source instance will be exposed under “instance,” as it may be with instance events. To differentiate set events from instance history, set events may use the “add” and “remove” actions. In a history, “add” may indicate the presence of a tuple in a set, and “remove” may indicate its absence at a timestamp. It may be noted that “action” may describe all variants of events (e.g., “create”, “update”, “delete”, “add”, and “remove”), much as a type tag may do. The database and drivers may distinguish these variants by “action”.

In embodiments, an events query function may be provided, such as “paginate” function for paging. To switch between snapshot and historical queries, clients may modify calls to paginate by adding an “events” parameter. To enable temporal features, the paginate function may be implemented twice, once for snapshots and once for history. Conflation of pagination with query semantics may be avoided by providing an events( )function which takes as its single argument any set and returns a representation of that set's history, configured as suitable for the paginate function.

An example of how existing queries might be expressed is shown using the events function. Before, a client wishing to page through the history of an instance, such as “classes/people/1,” might issue a query such as

```
{
    “paginate”: { “@ref”: “classes/people/1” },
    “events”: true
}
```

Using the events( )function, this same query would be expressed as:

```
{
    “paginate”:
        {
            “events”: { “@ref”: “classes/people/1” },
        }
}
```

The resulting query no longer conflates the items within the set passed to paginate( ) with the act of paging through the set. Pagination can thus be defined over any collection, including a snapshot or history, without concern for the structure of the items therein.

The semantics of paginate( )and events( )functions in composition are slightly more complex than in situations enabling only non-temporal features. Before, when paginate(events=true) was used, the paged sub-query was historical, and any sub-queries thereof were historical, etc., recursively. The events( )function as described above allows clients to selectively specify which sub-queries are snapshot or historical, enabling compositions that were previously impossible. An evaluation error may be rendered when a query is statically known to be nonsensical or unreasonable. For example, a rule may be set that events( )may not be a sub-query of events( ) This implies that all sub-queries of events( )may be required to be snapshot queries, eliminating troublesome patterns such as nested historical joins, and histories-of-histories.

In embodiments, a singleton query function may be provided, with the following characteristics relating to its semantics. There are two event timelines associated with an instance reference: the history of the instance's data, and the history of the instance's presence. The timeline of instance events represents the history of the instance's data over time. It can be obtained by passing the instance's reference to events( ) The events in this history include all create, update, and delete events in the instance's timeline, and include data as described with respect to instance events above.

The timeline of set events represents the history of the instance's presence in its singleton set over time. It can be obtained by passing the instance's ref to a new singleton( ) function. The set events in this history may be limited to create and delete events in the instance's timeline, such as rendered as “add” and “remove”, respectively. The data in these events is a singleton tuple containing the instance's reference. Calling paginate(events =true) with an instance reference may yield the history of that instance's data. A query structured as paginate(“classes/people/1”) will thus yield the same result as paginate(events(“classes/people/1”)).

An insert query function may be provided with defined semantics. As instance events are defined above, an event's action is relative to the preceding event, i.e., a non-delete event is an update if it is preceded by a create, and any other event is a create. Therefore, the insert( )function no longer needs to accept an action parameter. The semantics of insert( )may be defined such that an insert( )without data (in parameters) may yield a delete event with the given timestamp. Providing non-empty data to insert( )will yield either a create or an update with respect to events preceding the given timestamp.

The result of an insert( )query may be configured to render an event.

Semantics for a remove query function may be provided. In embodiments, no two events for the same instance may exist at the same timestamp. Therefore, the remove( )function does not require an action parameter. Semantics for remove( )may be defined to delete any instance event at the given timestamp.

With the provision of the event function variants described above, a total ordering may be defined such that two events at the same time will sort correctly in a timeline.

An instance cannot logically have two events at the same timestamp; that is, events with a later transaction time will always win, so the ordering of instance events is somewhat arbitrary. However, sets do commonly have both “add” and “remove” events at the same timestamp. In that case, the semantics may be defined to resolve the timeline, such as by setting a rule that “remove” always occurs before “add” in time. Instance events sharing the same timestamp may be ordered similarly to set events for logical consistency; that is, deletes may be defined to occur before updates, and updates may be defined to occur before create. The order between instance and set events sharing a timestamp may benefit from being stable while paging through heterogeneous sets, but it is somewhat arbitrary. It may be defined in various orders, such as, for example, asserting that removes occur before deletes, and creates occur before adds. Putting these definitions together we have: “remove” <“delete” <“update” <“create” <“add”.

### Streaming Queries

In embodiments, a database is provided that enables the streaming of queries. This may include streaming of queries as properties. For example, the database may enable a user to listen to a query live and receive updates about what elements were added or removed with respect to the query. This may be useful to as a message bus or when dealing with a real-time application, like a chat or a game. In embodiments, the database may stream any query as a general property, including a complex query, and receive live updates to the query, such as a change feed. In embodiments, the streaming of queries may use the temporal data model, such to enable change feeds and other capabilities.

### Security

Legacy additional databases 104 may implement schema-level user authentication only, being designed for small numbers of internal business users at workstations. But modern applications may be exposed to millions of untrusted and potentially malicious actors over the public internet and must implement identity systems, row-level security, and transport encryption at a minimum. Row-level security may include row-level identity, row-level authentication, and the like.

The database 100 may internalize these concerns in order to deliver both administrative and application-level identity and security either through API servers or directly to untrusted clients like mobile, browser, and embedded applications.

Pushing security concerns to the database guarantees that all applications interacting with the same data set implement the same access control, and dramatically reduces the attack surface, a critical business risk.

### Identity

Application actors in the database 100 (such as users or customers) may be identified either with built-in password authentication or via a trusted service that delegates authentication to some other provider. Once identified, application actors may receive a token they may use to perform further requests that close over their identity and access context.

This may allow untrusted mobile, web, or other fat clients to interact directly with the database and participate in the row-level access control system. Actors identified as instances 112 never have access to administrative controls.

System actors may be identified by the keys 106; the keys 106 may have a variety of levels of privilege. The keys 106 may close over a specific logical database scope and may not access parent additional databases 104 in the recursive hierarchy, although they optionally may access child additional databases 104.

### Access Control

System actors may have roles assigned to their keys 106 which may only be changed by a superior actor. These roles may limit activity to administrative access, read/write access to all instance data, or access to public instance data only.

An adaptive operational database may include a row-level security engine. The security engine 128 may include row-level security 168 for application access control, which may be managed through the assignment of identities and to read, update, create, and delete access control lists on the instances 112, the indexes 108, stored procedures, and the classes 110. A security engine 166 may also row-level security 168 to set security parameters on a per-application basis.

Data-driven rights decisions, such access groups, may be implemented by assigning access control query expressions to access control lists (ACLs). These query expressions may be parameterized on the object that contains the role and must return a set of identities allowed to fulfill the role.

The identity of an actor performing a transaction may be accessed within the context of a stored procedure in order to implement completely custom access logic within the database. The database 100 may transparently enforce row-level access control at all times; there is no way to circumvent it.

### Auditing and Logging

All administrative and application transactions in the database 100 may be optionally logged; additionally, the underlying temporal model may preserve the previous contents of all records within the configured retention periods.

Although the database 100 may not natively track data provenance, applications interacting with database 100 may tag every transaction with actor information and may access that data historically as part of the instance versions.

### Encryption

In embodiments, the database 100 may encrypt data on the wire. Cluster traffic may be encrypted via secure socket layer (SSL) and may be optionally authenticated via public/private key pairs specific to each node.

Traffic on public interfaces may also be encrypted via SSL. Applications interacting with the database 100 may be authenticated via public/private key pairs or may rely on a certificate authority to authenticate a certificate for the cluster itself

Operating system mechanisms such as filesystem encryption may be used to secure data at rest, logs, and any on-disk private keys 106.

### Encryption at Rest

In embodiments, the database may implement encryption features for data at rest. In embodiments, for example, every logical database (including for multi-tenant situations) may have its own symmetric encryption key, which itself may be stored encrypted by the root secret. Descending from the root, each time another secret is created, it may decrypt the symmetric key and re-encrypt it with the new secret, storing an additional copy. For new databases, a new encryption key may be created encrypted with every previous secret in the hierarchy of access. This way the encryption key never is stored in a decrypted state on disk and never passed over the wire. SSL termination in the server may be used to prevent local TCP sniffing of in-use keys. Compression, tokenization, etc. may be applied pre-encryption. In embodiments, an option to remove predecessors in the hierarchy would make data irrecoverable even by a host of the database platform.

In embodiments, wire encryption may also be replaced with the same symmetric keys, so that there is not a need to decrypt data on read. Aspects of metadata may not be encrypted to facilitate indexing or background tasks.

In embodiments, client-side encryption may be used, such that the database has no knowledge of the data whatsoever.

In embodiments, arrangements may be provided such that no single operator holds a complete password to decrypt the master key. An operator may decipher the master decryption key as long as it receives logins from at least two operators, at least three operators, etc. Attacking that key's encrypted store itself at rest, even in possession of two operators' passwords is not easy.

Another need is, once having the master key decrypted, securely delivering it to other components in the cluster that needed it. This may be accomplished by using SSL with client authentication. This introduces another point of security, as someone must be able to sign new certificates for new nodes in the database cluster.

### Scalability

The database 100 may be designed to be horizontally and vertically scalable, self-coordinating, and have no single point of failure. Every node in the database 100 cluster may perform three roles simultaneously. These roles may include serving as a query coordinator, serving as a data replica and serving as a log replica.

No operational tasks may be required to configure the role of a node.

### Cluster Topology

The database 100 cluster may be made up of three or more logical data centers (a physical data center may contain more than one logical data center).

The need to abstract operational management of the physical hardware from application decisions about compliance, redundancy, and latency is a primary requirement of adaptability. To achieve this abstraction in an adaptive operational database, replication may be configured dynamically, at the logical database level. Each physical data center may contain a copy of the global metadata, as well as copies of the contents of each logical database assigned to that data center.

For example, an enterprise may deploy a single database 100 cluster that spans multiple cloud infrastructure providers as well as on-premises hardware. Developers within the enterprise may choose on a database-by-database basis where they want to locate their application data, and change those decisions over time without operator intervention. The inverse may also be true; operators may change the physical composition of the cluster without affecting the replication strategies of individual applications.

In embodiments, a timestamp-based replication approach is implemented with a series of time-stamped, isolated snapshots are undertaken and then serialized as needed by re-ordering the snapshots.

### Routing

Any database node in any data center may receive a request for any logical database in the cluster. If the node does not own the data for that particular logical database, it may forward to a node that does, potentially in another data center. This may localize load to the data centers to which a logical database is assigned. Under some operational conditions, asymmetric routing may be used to partially localize bandwidth as well.

Once a transaction is routed to the correct data center, a local node may act as query coordinator and begin executing the transaction by pushing read predicates to data replicas that own the underlying data, waiting on the responses, and accumulating a write buffer if the transaction includes writes. Read predicates may be as simple as row-level lookups, or as complex as partial query subtrees. Multi-level predicate pushdown is supported. This may dramatically reduce latency and increase throughput via increased parallelism and data locality.

If a transaction is read-only (or asynchronous) a response may be returned to the client immediately; if the transaction includes writes, it may be forwarded to the appropriate log replica for transaction resolution. The log replica may forward the transaction to involved data replicas which may definitively resolve the transaction and return a response to the client-connected node, which may then return the response to the client.

### Data Partitioning

Within each data center, a logical data layout may be partitioned into a linear ring via a multi-level ordered hash. For example, data in a single database may be laid out together within the ring. Within that database instance data of the same class, and index entries for the same index may be grouped together. Since data ordering is total, range querying may be possible across any set of index terms or instance primary keys 106.

Although the database 100 may never update records in place, write hotspots may be still possible within a subrange. A background rebalancing task may run constantly at low priority to mitigate this. A background rebalancing task may be run by the background task engine 148.

Read and write hotspots may be possible if the read or write velocity of an instance (including its history) or a specific index entry exceeds the median size by a substantial margin. In this case, the database 100 may adaptively partition the instance or index entry across multiple ranges and perform a partial scatter-gather query on read.

### Fault Tolerance

The database 100 may be resilient to many types of faults that would affect availability in a less sophisticated system. In particular, the database 100 cluster may not be vulnerable to any single point of failure, even at the data center level.

Some specific faults that the database 100 may tolerate may be when a node is temporarily unavailable (process crash; hardware reboot), a node is permanently unavailable (physical hardware failure), a node becomes slow (local resource contention or degraded hardware) and a network partition isolates a data center—in this case, the isolated data center may continue to serve reads, but cannot accept writes.

The database 100 cluster may maintain availability in the face of faults due to the redundancy inherent in maintaining multiple replicas of the data set. For example, in a cluster configured with five data centers, as long as three data centers remain available, the cluster may respond to all requests.

Although the database 100 cluster may be capable of responding to transactions despite a partial or total failure in multiple data centers, it may still be in a degraded state. An additional concurrent failure in another data center may impact availability.

The database 100 may not automatically decommission failed nodes or data centers; this decision may be left to the operator to avoid triggering cascading failures.

In embodiments, the database platform may include various operational data management components, such as stream processing (like Spark/Yarn™ or Samza™), graph components (such as Neo4J™), caching (such as Memcached™), search components (such as ElasticSearch™), analytics components (such as Vertica™, Sybase™ and Redshift™), message brokering (such as Kafka™), storage components (such as S3™) and time series components (such as Influx™)

### Performance

Throughput for the database 100 may scale linearly. An adaptive operational database, unlike legacy SQL systems, may not impose thresholds in overall data set size that may trigger planning heuristic changes and may lead to unexpected performance faults.

Additionally, writes activity of an adaptive operational database may respond well under contention and may avoid interfering with reads or non-overlapping writes.

The database 100 may include a predicate pushdown function. Predicate pushdown may be extremely effective at parallelizing complex queries. Predicate pushdown may improve per-query latency with larger cluster size, both for committing writes, for observing write effects, and for performing compute on result sets, for example. For historical reasons, these capabilities may be rarely found in other distributed database systems.

### Durability

The database 100 may include a local store engine, also known as a local store module (LSM). A local store engine may be implemented as a compressed log-structured merge tree. Local store module (LSM) storage engines 144 may be well suited to both magnetic drives and SSDs. The storage engines 144 may be contained within the distributed storage engine 146. The distributed storage engine 146 may support multi-data center replication 176 and include distributed storage layer algorithms. Distributed storage layer algorithms may be a hybrid logical clock algorithm 178, transaction resolution algorithm 180, replication algorithm 182 and the like. The distributed storage engine 146 may also include an on-disk storage engine 184.

### Reads and Writes

The database 100 may include log-structured merge trees. Log-structured merge trees may be designed to transform random writes into bulk writes, dramatically increasing write throughput. Inserts, as well as delete markers, may be journaled to a flat commit log and accumulated in sorted memory tables. Because the temporal data model of the database 100 is composed of immutable versions, there may be no data overwrites except in special cases, for example.

When a memory table reaches a fixed size, it may be dumped to a disk as an immutable level in the log-structured merge tree. The memory table and the commit log may be then atomically flushed.

### Performance

A variety of other optimizations such as local index structures may be kept in memory of an adaptive operational database, to minimize the need to seek through each level file itself to find if a data item is present.

The level files themselves may be compressed on disk to reduce disk and IO usage. This may also improve the performance of the filesystem cache. Since level files may be immutable, compression may only occur once per level file, minimizing the performance impact.

In order to mitigate the latency impact of multi-level reads in an adaptive operational database, a local background process called compaction may be triggered when the number of levels exceeds a fixed size. Compaction may perform an incremental merge-sort of the contents of a batch of level files and may emit a new combined file. In the process, expired data may be evicted and delete markers may be dropped, shrinking the on-disk storage usage.

Compaction may be performed asynchronously, but progress must be guaranteed over time or read performance may degrade. The compaction tasks may be managed via a process scheduler of the database 100 in order to balance their resource requirements with the need to prioritize synchronous transactions.

### Consistency

The database 100 may include the consistency model 114. The consistency model 114 of the database 100 may be designed to deliver strict serializability across multi-key transactions in a globally-distributed cluster without compromising availability, scalability, throughput, or read latency.

In embodiments, a globally distributed cluster may be replicated to multiple geographically diverse data centers or cloud infrastructure providers. In embodiments, the database platform of the present disclosure maintains consistency under replication, including global replication across different storage environments and further including, in embodiments, maintaining consistency in cases where the database is installed on the information technology infrastructure of an enterprise (not just offered as a service).

All writes may be ordered based on their position in a global transaction log. Each node may be aware of its most recently applied log position, so all read transactions may be guaranteed to be consistent at the most recently replicated log position of the query coordinator that executes them. Database drivers maintain a high-watermark of the log position of their last request—equivalent to a causal token—guaranteeing a monotonically advancing view of the global transaction order.

Finally, write transactions may be restricted to a single logical database, but read-only transactions that recursively span multiple logical additional databases 104 may be performed at read-committed consistency if appropriate permissions have been assigned.

Transaction resolution in the database 100 may be based on the Calvin protocol, backed by an optimized version of Raft. Raft may serve to replicate a distributed transaction log, while Calvin may manage transaction resolution across multiple data replicas.

The database 100 based on a Calvin and Raft configuration may interact with temporality to improve read performance. The database 100 may store the history, so the Raft log may replicate history updates to the nodes, so nodes can pull reads from points in time in the past without coordination across the cluster. The database 100 based on a Calvin and Raft configuration may enable strongly consistent, full transaction reads, without having to cross the global Internet.

The database 100 based on a Calvin and Raft configuration may dynamically choose which physical data centers a logical data set should be replicated to. The database 100 may replicate a data set across different computing hardware, across geographies and the like.

A globally replicated transaction log may maintain an order of all transactions within a logical database. The log may be processed as an ordered series of batches called epochs. The typical epoch window in the database 100 may be 10-20 milliseconds, which may serve to allow the cluster to parallelize transaction applications, while minimally affecting transaction processing latency.

When a transaction is submitted to a query coordinator, the coordinator may stamp the transaction with the latest known log timestamp, and speculatively execute the transaction at that timestamp to discover read and write intents. If the transaction includes writes, it may then be forwarded to the nearest log replica, which may record it as a part of the next epoch, as agreed upon by consensus with the other replicas.

At this point, the only required cross-data center communication may have occurred. The order of transactions within the epoch and with respect to the transaction log may be resolved, and each data center may proceed independently and deterministically to resolve transaction effects.

The transaction may then be forwarded to each local data replica, as determined by its read and write intents. Each data replica may receive only the subset of transactions in the epoch that involve reads or writes of data in its partitions and processes them in the pre-determined order. Each data replica may block on reads for values it does not own and may forward reads to all other involved partitions for those it does. Once it receives all read values for the transaction, it may resolve the transaction and apply any local writes. If any preconditions of the original speculative execution fail, for example, a read dependent on a value that has changed may no longer be covered by the set of read intents, the transaction may be aborted.

Because a transaction log may maintain a global order of transactions, and data nodes may be aware of their own position in the log, reads may be consistently served from the local data center at all times, and the causal order of two transactions may always be determined by the ordering of their respective log positions.

Transaction throughput in Calvin-based systems is constrained by the degree of contention among nodes within each epoch. In embodiments, Resolution context in the database 100 may be partitioned by a logical database, so total transaction throughput is unbounded.

In embodiments, a distributed transaction log may be extended with streaming, recovery, compression, and retry mechanisms to improve performance.

In embodiments, a transaction resolution engine 180 may be extended with streaming, recovery, compression, and retry mechanisms to improve performance.

### Resiliency

The transaction processing pipeline of an adaptive operational database may be tolerant of node failure or latency at each step. If a coordinating node cannot communicate with the local log replica, it may safely forward its transaction to another log replica. If a data replica does not receive an epoch batch from the local log replica in a timely manner, it may retrieve the epoch batch from another log replica. If during transaction application, a data replica does not receive part of the transaction's reads from other partitions, it may safely read the missing values at the specific log position from other replicas of the failed partition.

### Quality of Service

In order to effectively respond to rapidly changing workloads, the database 100 may implement a process scheduler that may dynamically allocate resources and enforce quality of service. A scheduler may be implemented as a recursive series of work queues that may mirror the logical database hierarchy in the database 100 cluster. Individual transactions may be slotted into queues first by their execution context (synchronous or asynchronous), and secondarily by their priority context, which is either the priority of their logical database or the priority of their access key if it has one.

Execution may proceed via cooperative multitasking. Transactions may be selected for execution according to a recursive, weighted fair queuing algorithm and may be scheduled onto native threads. the database 100 may include a query planner. A query planner may evaluate transactions as a series of interleaved and potentially parallelizable compute and IO stages and may guarantee that execution may always yield at predictable and granular barriers (for example, loop iteration). This may restrict the complexity of continuations and may let the executor context switch and re-enter scheduling each time a predictable quantity of resources is consumed from each IO or compute execution thread, without requiring a complex and non-portable pre-emptive multitasking scheme.

In embodiments, the dynamic resource scheduling 126 is provided for the database. This may include scheduling use of resources across a database cluster, as well as scheduling resources at a granular level, rather than at the level of the entire logical database. Dynamic allocation of resources or the dynamic resource scheduling 126 may maximize utilization and minimize infrastructure footprint. The dynamic resource scheduling 126 may include a security model. A security model may isolate data itself to assign detailed priorities and access to the data on a granular level, including on a per-query level. The dynamic resource scheduling 126 may allow dynamic resource scheduling on a query-by-query basis, user-by-user basis, and the like.

### Security Model for Dynamic Resource Allocation

In embodiments, the security model isolates the data itself, so that a user can specify with complete granularity what user or process has access to what data, at what priority and with what access. Conventional databases focus on admin security, such as administering whether a user or process can access a given logical database, with little concept of access above a single logical DB (except for total administrative access to the machine). Conventional approaches do not typically let users control access to partial data sets within the database. The database platform described herein can provide a recursive hierarchy of data in the database (similar to folders on a file system). An enterprise can control access so that users can be given access to partial data sets (including in a hierarchy, rather than a flat set of access controls). Also, within each database of the platform, users can manage access to individual rows on a per-user basis. In cases of other databases, any row-level security, to the extent that it exists, is implemented without process isolation and in a difficult-to-verify way, so that most users do not use such features at all. Others conventional approaches do not secure the interface to the database. A user can claim to be a given user and to have access to particular rows, but the database is not capable of authenticating the user. The database platform described herein may provide identification and authentication, along with row-level security, all as native database functions without requiring application-level development in the applications that use the database.

Historically there have been platform-as-a-service systems like FireBase™ and Parse™ that were multi-tenant systems with limited, pre-configured row-level security, identity, and authentication models. Users could be given capabilities to access particular pieces of data, it was not possible to create multiple types of users or schemas, as in the database platform described herein. Because such systems did not have QoS management, it was not possible to expose sophisticated query models (e.g., to assign resources across queries).

In the platform described herein, an enterprise or other users can say, for example, “this user of this app can only access the data that the user creates,” such as within an application context, and the user can then only access those particular records. An enterprise might, for example, give an analytics team read-only access to everything (e.g., to all data sets, but without the ability to write or modify data). A traditional SQL database would have to assign those types of rules on a per dataset basis and could not constrain access by a single user to the user's own creations at all. It could not expose data to the user to talk to the database without going through an API/proxy or similar system, adding complexity, latency and overhead.

The database 100 may include a recursive hierarchy of data on the database. A recursive hierarchy may allow operators to control hierarchical access so that access to partial data sets may be provided. A recursive hierarchy may also allow an operator to manage access to individual rows on a per-user and/or per-database basis. A recursive hierarchy may allow the creation of multiple types of users and schemas. For example, a recursive hierarchy may allow an operator to grant a user of the database 100 access only to data created by the user.

The overall impact is that workloads of the database 100 may be recursively ordered by business priority, and low priority tasks may burst into whatever idle capacity remains in the cluster, dramatically improving aggregate utilization. The more diverse applications, data sets, and workloads may be hosted in a single database cluster, the better the price/performance becomes compared to a traditional, statically provisioned siloed data architecture.

Quality of service (QoS) may be assigned on a per-query basis by the QoS management engine 124. Quality of service may include the process isolation engine 130. Process isolation 130 may allow an operator to vary the execution priority of queries against the same data. For example, an operator may assign customer-facing queries high priority and assign analytics queries to build reports a low priority. Low priority queries may get preempted when there is a spike in customer usage.

The process isolation engine 130 may allow an operator to sequence queries in time according to the relative priority. The process isolation engine 130 in the database 100 may be deeply embedded into the database kernel. The process isolation engine 130 may allow operators to control latency profiles for different features. The process isolation engine 130 may be implemented using a recursive process executor or 186, also known as a scheduler, a process scheduler, a recursive process scheduler, a recursive implementation of a completely fair queuing (CFQ) algorithm 188, and the like.

### Benefits of Process Isolation

As noted, the database may include the process isolation engine 130. Process isolation allows conflicting workloads to be safely and securely hosted in one database cluster, similar to a container system. Process isolation within the database allows a user to vary the execution priority of queries against the same data. Application priority can be done in another system, but process isolation within the database allows various activities that benefit from process isolation with less complexity and with less hardware. For example, an enterprise may give customer-facing queries high priority and give less critical items, like analytics queries used to build standard reports, a relatively low priority (so that, for example, lower priorities they get preempted when there is a spike in customer usage). In conventional systems (such as in PostgreSQL™ or Oracle™ databases), users need to provision systems statically to allow for peak capacity. If the user is running resource-intensive, low-value tasks, the user nevertheless has to provision enough physical hardware so that when those run, they do not interfere with everything else that is going on. As a result of the need to provision for peak capacity, most enterprises average single-digit utilization, meaning most of them are paying a significant premium for hardware to ensure sufficient availability for resources to support varying levels of query processes.

In embodiments, the database platform can use virtualization and container systems to provision or segment the hardware resources used for the database. Process isolation (including isolating QoS for each process), allows an enterprise to segment out processes in time according to the relative priority (and that isolation capability is embedded into the database kernel of the database platform described herein. With only rare exceptions, conventional database systems just distribute resources equally to all queries that are active at any one time. Certain query patterns tend to starve others in unpredictable ways. As a result, it is quite risky to run high-value, low-resource queries and low-value, high resource queries in the same conventional, so most enterprises run items like analytics in an entirely different database from operational processes, applications, and services. Even the rare systems that allow a user to assign priority at the logical database level do not enable isolation of queries that are operating on the same data set within the database.

A significant benefit of doing process isolation and QoS in the database kernel is that an operator can consolidate hardware and eliminate wasted capacity. Also, application developers can control the latency profile for different features, services, processes, and the like. Also, there is no need to provision a different cloud or slice of hardware for different tenants; in fact, no static provisioning decision needs to be made. Instead, with QoS defined for each process, users can run queries, start getting data, and add hardware as needed.

### Background Tasks

The database 100 may include the background task engine 148. The background task engine 148 may run background tasks. Background tasks may include schema changes, anti-entropy checks, user-submitted long-running queries, and the like. Background tasks in the database 100 may be managed internally by a journaled, topology-aware task scheduler. The background task engine 148 may include a directed acyclic graph (DAG) task execution engine 174.

In embodiments, the database enables the ability to execute a directed acyclic graph (DAG) of tasks (such as analytics tasks) as a process against the operational data of an enterprise that is stored in the database.

Applications may interact with a task scheduler by submitting background queries. For example, the simplest transaction may map over some subset of a logical database and emit a result set. More complex pipelines may process data through a directed acyclic graph of transformations and aggregations. At each step of the way, intermediate results may be journaled locally as a subtask progresses. The results may be then repartitioned and forwarded to responsible nodes, and then either persisted or passed to the next processing step.

Background queries may execute on a snapshot of a state of the database 100 in order to provide an immutable, consistent state to the logic of a specific query. The final results of a background query may be published via an entry in the normal transaction processing pipeline as a series of new or updated instances 112.

### Aggregations

The database 100 may support common aggregations as built-ins, arbitrary user-defined aggregations and a range queries within a term.

Aggregations may have components. A component may be, a user-defined or built-in aggregation function type. A user-defined or built-in aggregation function type may have the following internal interface:

initialize: T

add(L, T): T

remove(L, T): T

merge(T, T): T

finalize(T): L

Where T is the type of the internal aggregation state, L is the type of the element being aggregated. Note that merge( )must be commutative and associative, and that merge(initialize( ) initialize( )) must equal initialize( ). If not enforced, this should at least be documented.

In an example, an average may look like:

def initialize: return (0,0)

def add(el, (sum, count)): return (sum+1, count+el)

def remove(el, (sum, count)): return (sum−1, count−el)

def merge((sum1, count1), (sum2, count2)): return (sum1+sum2, count1+count2)

def finalize((sum1, count1)): return sum1/count1

A function definition API may parallel the generic functions/stored procedures in structure, and be allowed to refer to generic functions, to DRY up definitions. Generic functions may also be callable on regular result sets in the course of query execution, which may make them more generally useful and easier to test.

In an example, they may be called using this method:

call(aggregation function, *L): add and finalize an aggregation of one or more elements

Continuing with this example, for indexes, to aggregate something, a special kind of index may be created that has:

term bindings

value bindings

aggregation bindings

Aggregation bindings may look like function calls on input elements and may refer to user-defined or built-in aggregation functions.

Aggregation bindings may always come last. If an index has aggregation bindings, it may no longer be guaranteed to have a value tuple per ref. Values may act like sub-terms instead. With strong consistency, it may be possible to dead reckon adds and removes to the aggregations. As versions are created, updated, and removed, a value in the doclist may be temporally updated.

If an index covers any values, and not just aggregations, then it may do range queries on value pairs in a match( )or range( )function and pass them to an aggregation function again to merge them.

Common aggregations may include built-in functions. Built-in functions may include:

max( ) equivalent to top(1)

min( ) equivalent to bottom(1)

count( ) counts the number of elements

distinct( ) keeps of list of unique L′s

sum( ) keeps a sum of all elements seen

average( ) keeps the average

median( ) keeps the median

Additional built-in functions may include lossy aggregations. Lossy aggregations may include:

top(N): retain the N smallest L′s in an ordered list

highscore list of (score, gameID)

bottom(N): inverse of above

histogram( . . . ): maintain a histogram with user-defined bucketing

The value in an index doclist may be type T, but match( )results may apply a finalizer and may be of type L. A developer may normally never see type T in result sets. Type T may be made available by the database 100 as metadata.

If an index has multiple terms, the same aggregation may be run at each term level. This may allow a user of the database 100 to create tiered buckets.

The database 100 may materialize partial aggregation snapshots every N entries, and compute final results at runtime based on the snapshots plus the leading or trailing index tuples or instances.

Tiers of a multi-term indexed aggregation may be merged instead of calculated multiple times.

### Job Scheduler

The database 100 may include a job scanner. A job scanner may automatically schedule recurring maintenance tasks. Recurring maintenance tasks may be continuous, administrative tasks and single-issue tasks. Single-issue tasks may be triggered by user actions. A user action may be a modifying index definition action. The database 100 may perform introspection of scheduled, running and recently finished tasks.

A job scanner may include a constantly-running loop over the data set, also known as a table scan. A table scan may execute a set of outstanding job requests for each live row it encounters. Throttling may be globally applied at this level.

A subsystem directly above a table scanner may maintain a list of in-flight jobs being applied to the underlying data. This subsystem may monitor activity on a job queue and injects new jobs into the in-flight list as they arrive. Once an in-flight job has been applied to the entire dataset, the job may be marked finished.

In an exemplary and non-limiting embodiment, this job scanner architecture may be implemented in code as follows:

```
foreach Row in Tables: // throttled
foreach Job in Queue:
      Job(Row) match { // in practice, ack/error is batched
      case Done => acknowledge job
      case Error => retry N times
      case _ => continue
```

A job may maintain its own completion state and acknowledgment semantics. Jobs must be idempotent, as a job scheduler may implement “at least once” semantics in a queue.

The database 100 may throttle scanner throughput via a simple sleep between iterations based on the number of bytes read by the database 100 in a current iteration.

The database 100 may include a scanner. A scanner may operate over a snapshot of a dataset.

The database 100 may include a mapper. A mapper may scan over a subset of instances in the dataset using a scanner. If a task is interested in an instance, it may return a closure to be applied to each version in the Instance.

Mappers may execute jobs. Jobs may include user-initiated requests (index construction, &c.) and administrative tasks (data garbage collection, repartitioning, &c.)

A mapper may check an input queue for user-initiated work and may mix those jobs into its statically-defined administrative tasks.

A mapper may execute a map task. A map task may be composed of callbacks.

Tasks may need to execute work after all instance versions have been consumed. A mapper may arrange to call a second callback once more with an empty set to indicate end-of-data.

### Queue

The database 100 may include a queue. A queue may be time-partitioned. A queue may support job state.

A queue may include a time parameter. A time parameter may be preexisting. A time parameter may be used as the time at which a job becomes eligible for execution.

A queue may include a state parameter. A state parameter may be a scheduled state parameter, processing state parameter and finished state parameter.

A queue may include enqueue functions.

A queue may include dequeue functions.

The database 100 may maintain one queue per replica as an analog to a persistent, typed channel to that node. Coordinator nodes for single-issue jobs of the database 100 may fan out jobs to each replica in a topology.

Background tasks may be limited to one instance across a cluster or per database, or be assigned a specific data range. If a background task is assigned a specific data range, an executing node may be one that is a data replica for that range. The execution state of each background task may be persisted in a consistent metadata store, causing scheduled tasks to run in a node agnostic manner. For example, if a node fails or leaves the cluster, its tasks may be automatically reassigned to other valid nodes and restarted or resumed.

The database 100 may include a resource scheduler. Background task execution throughput may be controlled by the resource scheduler of an adaptive operational database. For example, general background task work not associated with any tenant may be run at low priority, allowing the background task to proceed as idle resources allow and eliminate the impact of background tasks on synchronous requests.

### Operational Management

The operational management infrastructure of the database 100 may reuse the consistency mechanism and process scheduler to guarantee that the database is always in a coherent state and that work generated by operational changes does not adversely affect other workloads.

### Topological Changes

The replication topology of the database 100 cluster may be maintained as a consistent state machine. When the cluster state changes, the desired state may be committed to a consistently replicated metadata store on all nodes, and background tasks may incrementally transition the cluster from the current to desired state.

State transitions may include adding, removing, or replacing a physical node in the cluster, adding or removing a data center, changing the replication configuration of a logical database and the like.

During cluster transition states, node failures and other interruptions may not affect cluster availability. If the node running the supervisor process fails, then its lease on the supervisor role may expire and another node may assume the role. All incremental steps within each transition process may be idempotent and may be safely restarted or reverted.

### Other Maintenance Tasks

The database 100 may include other maintenance tasks. Other maintenance tasks may include, taking logical and storage-format backups, performing anti-entropy checks, and upgrading the on-disk storage format.

These maintenance tasks may not require a state machine transition, but may still rely on the process scheduler to avoid impacting production traffic.

Detailed embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The terms “a” or “an,” as used herein, are defined as one or more than one. The term “another,” as used herein, is defined as at least a second or more. The terms “including” and/or “having,” as used herein, are defined as comprising (i.e., open transition).

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions, and the like. The processor may be or may include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions, and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client, and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, and the like. Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure, and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A database system comprising:
a database having a query engine that enables multiple query models, the query models including at least two query models selected from among SQL-format queries, noSQL format queries, graph-based queries, geospatial queries, and analytic-format queries, key/value queries, document queries, temporal queries, and search queries; and
a set of database functions configured to respond to queries against the database delivered via the query engine,
wherein the database enables recursive multi-tenancy configuration and operation.

2. The database system of claim 1, wherein the database provides a row-level security access feature.

3. The database system of claim 1, wherein the database provides a row-level handling of identity.

4. The database system of claim 1, wherein the database provides a row-level handling of authentication.

5. The database system of claim 1, wherein the database has an elastic architecture.

6. The database system of claim 1, wherein the database enables masterless configuration and operation.

7. The database system of claim 1, wherein the database is configured to be replicated to multiple geographically diverse data centers or cloud infrastructure providers.

8. The database system of claim 1, wherein the database is deployed with a relational query language.

9. The database system of claim 1, wherein the database is provided with process isolation capabilities.

10. The database system of claim 1, wherein the database is deployed with recursive scheduling to enable process isolation for the database.

11. The database system of claim 1, wherein the database is deployed with recursive implementation of completely fair queuing in connection with process isolation.

12. The database system of claim 1, wherein the database is deployed with dynamic resource scheduling including across a database cluster of the database.

13. The database system of claim 1, wherein the database is deployed with dynamic resource scheduling on a query-by-query basis.

14. The database system of claim 1, wherein the database is deployed with dynamic resource scheduling on a user-by-user basis.

15. The database system of claim 1, wherein the database is deployed with a distributed storage layer.

16. The database system of claim 15, wherein the distributed storage layer is deployed with a transaction resolution algorithm.

17. The database system of claim 1, wherein the database is distributed and the database is deployed with a replication algorithm using a replication log that replicates information to different storage nodes of a distributed storage layer.

18. The database system of claim 1, wherein the database is deployed with an on-disk storage engine.

19. The database system of claim 1, wherein the database is provided having per query quality-of-service management.

20. The database system of claim 1, wherein the database enables a native running of background analytic tasks in the database.

21. The database system of claim 1, wherein the database is an operational database and a direct acyclic analytic task graph is operated against the database.

22. The database system of claim 1, wherein the database includes columnar analytics capabilities.

23. The database system of claim 1, wherein the database enables a streaming of queries.

24. The database system of claim 1, wherein the database implements a semi-structured, schema free data model.

25. The database of claim 1, wherein the database maintains the history of each record and index within a configurable retention window.
